(19) United States
(12) Patent Application Publication
(10) Pub. No.: US 2009/0104091 A1
(43) Pub. Date: Apr. 23, 2009

(54) Exhaust Treatment Apparatus And Method Of Making

(75) Inventors: Bruce B. Hoppenstedt, Lakeville, MN (US); Jared Dean Blaisdell, Blaine, MN (US); Gary Dale Reeves, Lakeville, MN (US); Allan T. Hovda, Savage, MN (US)

Correspondence Address: MERCHANT & GOULD PC, P.O. BOX 2903, MINNEAPOLIS, MN, 55402-0903, US

(73) Assignee: DONALDSON COMPANY, INC., Minneapolis, MN (US)

(21) Appl. No.: 11/661,567

(22) PCT Filed: Aug. 30, 2005
(86) PCT No.: PCT/US2005/031203

§ 371 Date: Sep. 22, 2008

Related U.S. Application Data
(60) Provisional application No. 60/606,025, filed on Aug. 31, 2004.
(60) Provisional application No. 60/606,030, filed on Aug. 31, 2004.

(51) Int. Cl. F01N 3/28; B32B 37/06

(52) U.S. Cl. 422/179; 156/60

(57) ABSTRACT

The present disclosure relates to an exhaust aftertreatment device (30) having a core (18) and an outer housing (40) and a mounting layer (50) positioned between the core (18) and the outer housing (40). The core has an upstream end face (20) and a downstream end face (22). The mounting layer (50) and the housing (40) have main portions (52) that extend from the upstream end face (20) to the downstream end face (22) of the core (18). The mounting layer (50) and the housing (40) also include end portions (40a, 40b) that overlap the end faces of the core (18) to retain the core within the housing (40). The end portions (50a, 50b) of the mounting layer (50) are compressed against the end faces of the core (18) by the end portions (40a, 40b) of the housing (40).

This application is being filed on 30 Aug. 2005, as a PCT International Patent application in the name of Donaldson Company, Inc., a U.S. national corporation, applicant for the designation of all countries except the US., and Bruce Bernard Hoppenstedt, Jared Dean Blaisdell, Gary Dale Reeves, and Al Hovda, all citizens of the US, and claims the priority to U.S. Provisional Application No. 60/606,030 filed Aug. 31, 2004, and U.S. Provisional Application No. 60/606,025 filed Aug. 31, 2004, which applications are hereby incorporated by reference in their entirety.

### TECHNICAL FIELD

The present invention relates generally to engine exhaust treatment devices having cores such as catalytic converters or diesel particulate filters and methods for making such exhaust treatment devices.

### BACKGROUND

To reduce air pollution, engine exhaust emissions standards have become increasingly more stringent. Catalytic converters have been used to reduce the concentration of pollutant gases (e.g., hydrocarbons, carbon monoxide, nitric oxide, etc.) exhausted by engines. With respect to diesel engines, diesel particulate filters have been used to reduce the concentration of particulate matter (e.g., soot) in the exhaust stream.

U.S. Pat. No. 5,355,973, which is hereby incorporated by reference, discloses an example catalytic converter. Referring to FIG. 3 of the '973 patent, the catalytic converter includes a ceramic substrate or core 100 that defines a plurality of longitudinal channels. A catalyst is provided on the core 100. The core 100 is mounted within an outer metallic casing 105 or “can.” An intumescent mantle or mat 101 is positioned between the core 100 and the casing 105. The ends 106, 107 of the casing 105 are bent over to retain the core 100 within the casing 105. A gasket 109 is positioned between the ends 106, 107 and the end faces of the core 100.

U.S. Pat. No. 4,851,015, which is hereby incorporated by reference, discloses an example diesel particulate filter. As shown in FIG. 7 of the '015 patent, the filter includes a porous ceramic core 104 that defines a plurality of longitudinal channels. Adjacent longitudinal channels are plugged at opposite ends of the core 104. The plugged ends force exhaust gases to flow through the walls of the substrate so that soot is collected on the walls as the gases pass therethrough. The core 104 is mounted within a metallic housing 108. An intumescent material 106 is positioned between the core 104 and the housing 108. Ends 110 of the housing are bent over to retain the core 104 within the housing 108. A sealing/gasket material is positioned between the ends 110 and the end faces of the core 104. For some applications, a catalyst can be provided on the substrate such that the filter functions like a catalytic converter to reduce the concentration of pollutant gases such as hydrocarbons and carbon monoxide.

The gaskets at the ends of aftertreatment devices described above prevent exhaust gas from impinging on the ends of the intumescent material and physically eroding the material. The gaskets also prevent exhaust from leaking between the core and the casing, and cooperate with the ends of the casing to axially retain the core within the casing. The gaskets typically include materials such as fiberglass, wire mesh, or other heat resistant material.

While gaskets are functional, there are disadvantages associated with the use of gaskets. For example, gaskets add to the number of parts required to manufacture an aftertreatment device thereby increasing manufacturing/assembly complexity and increasing cost. Also, certain gaskets can abrade the core and/or the cushioning layer. Furthermore, the mismatch of gasket and cushioning layer material properties can result in uneven radial forces over the gasket/cushioning layer interface over the range of operating temperatures.

### SUMMARY

One aspect of the present disclosure relates to an exhaust aftertreatment device having a core, an outer housing, and a mounting layer positioned between the core and the outer housing. The core has an upstream end face and a downstream end face. The mounting layer and the housing have main portions that extend from the upstream end face to the downstream end face of the core. The mounting layer and the housing also include end portions that overlap the end faces of the core to retain the core within housing. The end portions of the mounting layer are preferably compressed against the end faces of the core by the end portions of the housing. In a preferred embodiment, the end portions of the mounting layer seal the ends of the housing thereby eliminating the need for separate gaskets.

Another aspect of the present disclosure relates to a method for making an aftertreatment device including a substrate, a metallic housing and a non-intumescent mat. Pursuant to the method, substrate retention is improved by heating the aftertreatment device to a temperature and for a duration to cause oxidation of the housing and removal of at least some contaminants provided at boundary layers between the substrate and the mat and between the mat and the housing. The heating is preferably part of a manufacturing process that occurs prior to installation of the aftertreatment device in an exhaust system.

A variety of other aspects of the invention are set forth in part in the description that follows, and in part will be apparent from the description, or may be learned by practicing the invention. The aspects of the invention relate to individual features as well as combinations of features. It is to be understood that both the foregoing general description and the following detailed description are exemplary and explanatory only and are not restrictive of the invention as claimed.

### BRIEF DESCRIPTION OF THE DRAWINGS

FIG. 1 is a cross sectional view of an aftertreatment device having features that are examples of inventive aspects in accordance with the principles of the present disclosure;

FIG. 2 is a cross sectional view of a second aftertreatment device having features that are examples of inventive aspects in accordance with the principles of the present disclosure;

FIG. 3 is a cross sectional view of a third aftertreatment device having features that are examples of inventive aspects in accordance with the principles of the present disclosure;

FIG. 4 is an enlarged view of a portion of an aftertreatment device in accordance with the principles of the present disclosure, the aftertreatment device is shown prior to bending the ends of an outer housing of the device radially inward to secure a substrate within the housing;

FIG. 5 is a cross-sectional view of an aftertreatment device having a mat layer encapsulated within a protective material; and

FIG. 6 is a cross sectional view of an aftertreatment device including a housing wherein the ends of the housing have been extended and curled leaving gaps between the curled ends and end faces of a substrate.

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION

In the following detailed description, references are made to the accompanying drawings that depict various embodiments in which the invention may be practiced. It is to be understood that other embodiments may be utilized, and structural and functional changes may be made without departing from the scope of the present invention.

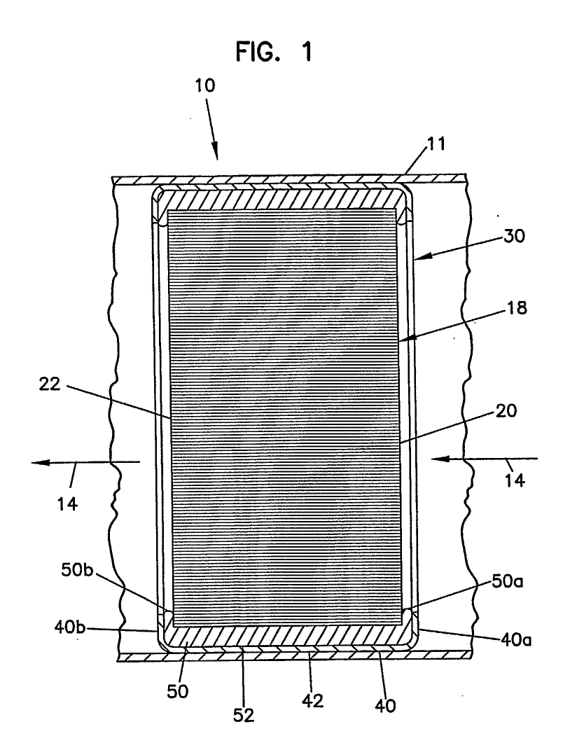

FIG. 1 illustrates a portion of an engine exhaust system 10 that includes, among other elements, an engine exhaust conduit 11 (e.g., a muffler, housing, pipe or other structure) and an aftertreatment device 30 that mounts within the exhaust conduit. The aftertreatment device 30 includes a substrate 18 having an upstream face 20 and a downstream face 22. Flow arrows 14 illustrate that the direction of exhaust gas flow is from the upstream face 20 to the downstream face 22 of the aftertreatment device 30. In one embodiment, the aftertreatment device 30 can be incorporated into a relatively low temperature the exhaust system (e.g., less than 300 degrees Celsius) such as the exhaust system for a diesel engine.

The aftertreatment device 30 can include a catalytic converter, a diesel particulate filter, a lean NOx catalyst device, a selective catalytic reduction (SCR) catalyst device, a lean NOx trap, or other device for removing for removing pollutants from the exhaust stream. The configuration of the substrate 18 will vary depending upon the intended function of the device 30.

Catalytic converters are commonly used to convert carbon monoxides and hydrocarbons in the exhaust stream into carbon dioxide and water. Diesel particulate filters are used to remove particulate matter (e.g., carbon based particulate matter such as soot) from an exhaust stream. Lean NOx catalysts are catalysts capable of converting NOx to nitrogen and oxygen in an oxygen rich environment with the assistance of low levels of hydrocarbons. For diesel engines, hydrocarbon emissions are too low to provide adequate NOx conversion, thus hydrocarbons are required to be injected into the exhaust stream upstream of the lean NOx catalysts. SCR's are also capable of converting NOx to nitrogen and oxygen. However, in contrast to using HC's for conversion, SCR's use reductants such as urea or ammonia that are injected into the exhaust stream upstream of the SCR's. NOx traps use a material such as barium oxide to absorb NOx during lean burn operating conditions. During fuel rich operations, the NOx is desorbed and converted to nitrogen and oxygen by catalysts (e.g., precious metals) within the traps.

Diesel particulate filter substrates can have a variety of known configurations. An exemplary configuration includes a monolith ceramic substrate having a “honey-comb” configuration of plugged passages as described in U.S. Pat. No. 4,851,015 that is hereby incorporated by reference in its entirety. Wire mesh configurations can also be used. In certain embodiments, the substrate can include a catalyst. Exemplary catalysts include precious metals such as platinum, palladium and rhodium, and other types of components such as base metals or zeolites.

For certain embodiments, diesel particulate filters can have a particulate mass reduction efficiency greater than 75%. In other embodiments, diesel particulate filters can have a particulate mass reduction efficiency greater than 85%. In still other embodiments, diesel particulate filters can have a particulate mass reduction efficiency equal to or greater than 90%. For purposes of this specification, the particulate mass reduction efficiency is determined by subtracting the particulate mass that enters the filter from the particulate mass that exits the filter, and by dividing the difference by the particulate mass that enters the filter.

Catalytic converter substrates can also have a variety of known configurations. Exemplary configurations include substrates defining channels that extend completely therethrough. Exemplary catalytic converter configurations having both corrugated metal and porous ceramic substrates/cores are described in U.S. Pat. No. 5,355,973, that is hereby incorporated by reference in its entirety. The substrates preferably include a catalyst. For example, the substrate can be made of a catalyst, impregnated with a catalyst or coated with a catalyst. Exemplary catalysts include precious metals such as platinum, palladium and rhodium, and other types of components such as base metals or zeolites.

In one non-limiting embodiment, a catalytic converter can have a cell density of at least 200 cells per square inch, or in the range of 200-400 cells per square inch. A preferred catalyst for a catalytic converter is platinum with a loading level greater than 30 grams/cubic foot of substrate. In other embodiments the precious metal loading level is in the range of 30-100 grams/cubic foot of substrate. In certain embodiments, the catalytic converter can be sized such that in use, the catalytic converter has a space velocity (volumetric flow rate through the DOC/volume of DOC) less than 150,000/hour or in the range of 50,000-150,000/hour.

Referring back to FIG. 1, the substrate 18 of the aftertreatment device 30 is mounted within a protective housing 40. A mounting layer 50 is preferably positioned between the substrate 18 and the housing 40. In certain embodiments, the substrate 18 and the housing 40 can be generally rounded (e.g., cylindrical, oval, elliptical, or other shapes) with the mounting layer 50 forming a sleeve that wraps about the exterior of the substrate 18 and lines the interior of the housing 40. The mounting layer 50 is shown including a main portion 52 that extends from the upstream face 20 to the downstream face 22 of the substrate 18. The mounting layer 50 is compressed radially inwardly by a main portion 42 of the housing 40. The mounting layer 50 also includes end portions 50a and 50b that respectively oppose the upstream face 20 and the downstream face 22 of the substrate 18. End portions 40a and 40b of the housing 40 compress the end portions 50a, 50b of the mounting layer 50.

The end portions 40a, 40b form substrate retention structures (e.g., lips, flanges, tabs, indentations or other structures) at the ends of the device 30. In one embodiment, each of the retention structures comprises a lip that extends continuously about the entire 360 degree perimeter of the device 30. In other embodiments, the retention structures may be located at only portions of the perimeter of the device 30. In certain embodiments gaskets or other structures can be used to seal the ends of the device.

The mounting layer 50 can be adapted to perform a number of functions. For example, the main body 52 of the mounting layer 50 can transfer radial pressure between the housing 40 and the substrate 18. This radial loading assists in retaining the substrate 18 within the housing 40. The mounting layer 50 also preferably provides a cushioning function for reducing the vibrations that are transferred from the housing 40 to the substrate 18. Furthermore, the mounting layer 50 is preferably adapted to provide a thermal insulating function. Moreover, the end portions 50a, 50b of the mounting material 50 transfer axial pressure between the ends 40a, 40b of the housing 40 and the end faces 20, 22 of the substrate 18.

The mounting layer 50 can also be referred to a mat, mantle, cushioning layer, sleeve or like terms. It is preferred for the main body 50 and the ends 50a, 50b to have the same or similar physical characteristics. In a preferred embodiment, the main body 50 and the ends portions 50a, 50b are made of the same material so as to have identical physical characteristics. In one embodiment, the mounting layer 50 comprises a mat that extends continuously, in an uninterrupted fashion, from the end 50a to the end 50b such that an integral connection exists between the main body 50 and the end portions 50a, 50b.

Two known types of mat material include intumescent mat material and non-intumescent mat material. Intumescent mat material typically includes a chemical compound such as vermiculite that expands in reaction to elevated temperatures. Thus, aftertreatment devices including intumescent mat materials are typically heated after assembly to cure and expand the mat material. Non-intumescent mat materials typically do not includes chemical compounds such as vermiculite that expand in reaction to elevated temperatures. Thus, a selling point of non-intumescent mat materials is that they provide a “no-cure” approach to substrate retention.

A preferred material for the mounting layer 50 includes a non-intumescent material. Non-intumescent materials typically do not include chemical compounds such as vermiculite that expand in reaction to elevated temperatures. Preferred mounting materials include erosion resistant fibrous mats such as ceramic fibers, aluminum fibers, silica fibers or other materials. Non-intumescent mat materials can include erosion resistant properties, and also are capable of providing compression “spring” that provides constant holding pressure across a relatively large temperature range. Example non-intumescent materials include the CC-Max® 4 Substrate Support Mat and the CC-Max® 6 Substrate Support Mat sold by Unifrax Corporation of Niagara Falls, N.Y. Another support mat includes the Interam 1101 HT Mat sold by Minnesota Mining and Manufacturing Company of St. Paul, Minn. While non-intumescent mats are preferred, erosion resistant intumescent mats can also be used.

The housing 40 of the aftertreatment device 30 is preferably constructed of a metallic material such as stainless steel or other metals. Housing 40 can also be referred to as a “can”, “casing”, “canister”, or like terms.

In the embodiment of FIG. 1, the mounting layer 50 forms the dual role of applying radial pressure about the circumference of the substrate 18, and also applying opposing axial pressures to the end faces 20, 22 of the substrate 18. The ends 50a, 50b of the mounting layer 50 eliminate the need for separate gaskets or other sealing structures at the end of the aftertreatment device 30 thereby reducing the total number of loose parts required to manufacture the aftertreatment device and also enhancing manufacturing efficiency.

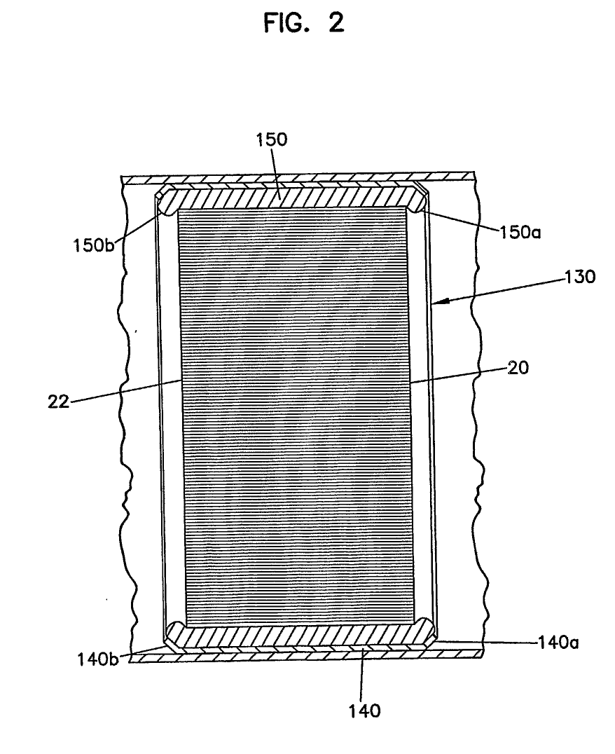

In the embodiment of FIG. 1, the ends 40a, 40b of the housing 40 are bent at approximately 90 degree angles relative to the main body 42. FIG. 2 shows an alternative aftertreatment device 130 having a housing 140 with end portions 140a and 140b that are bent at angles less than 90 degrees relative to a main body of the housing 140. The embodiment 130 also includes a mounting layer 150 having end portions 150a, 150b that are compressed against the axial end faces 20, 22 of the substrate 18. The mounting layer 150 can have a similar material construction as the layer 50 described above.

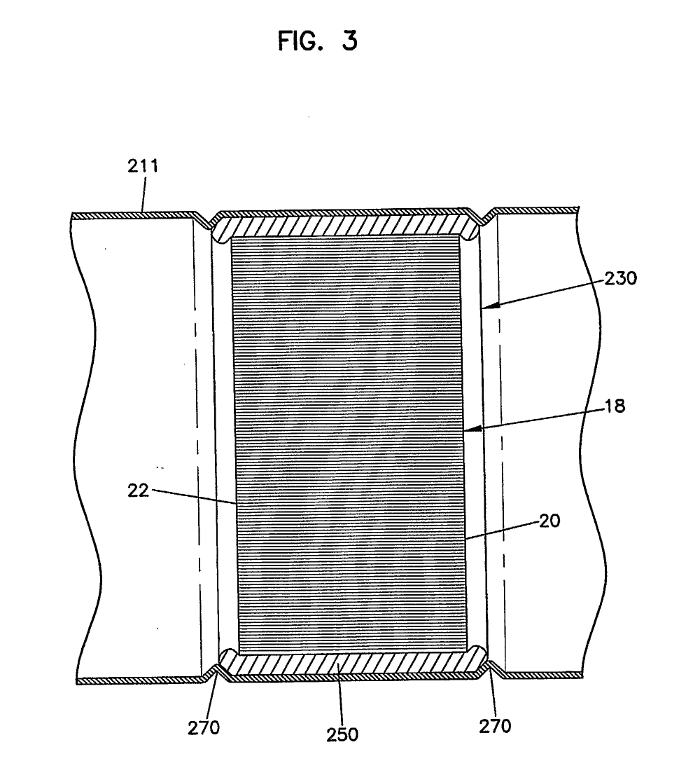

FIG. 3 shows an aftertreatment device 230 that is mounted directly in an exhaust conduit 211 without the use of an intermediate housing. As shown in FIG. 3, the device 230 includes a substrate 18 having end faces 20, 22. A mounting layer 250 is wrapped about the perimeter of the substrate 18 and is radially compressed between the substrate 18 and the conduit 211. The mounting layer 250 can have a similar material construction as the layer 50 described above. The conduit 211 includes integral retention structures 270 positioned at opposite ends of the device 230. The retention structures project inwardly in a radial direction and compress end portions 250a, 250b of the mounting material against the end faces 20, 22 of the substrate 18. As shown in FIG. 3, the retention structures 270 include indentations that extend continuously for 360 degrees about the ends of the substrate 18. In other embodiments, a plurality of discrete or non-continuous indentations or other radial projections could be used as retention structures.

While aftertreatment devices in accordance with the principles of the present disclosure can be manufactured by a number of different techniques, a plurality of non-limiting example manufacturing methods for manufacturing the device 30 is set forth below. Pursuant to an example method, the aftertreatment device 30 is manufactured by first wrapping the mounting material 50 (e.g., a non-intumescent material) about the circumference of the core 18 with longitudinal edges of the material being positioned adjacent to one another to form a longitudinal seam. The seam can be formed by overlapping the longitudinal edges or butting the longitudinal edges together. A fastening mechanism such as tape or other material can be used to secure the edges together. Once the material 50 has been wrapped about the substrate 18, the substrate with the material mounted thereon can be slipped into a pre-rolled metallic sheet (e.g., a precursor housing). The sheet is then compressed radially about the substrate to compress the material 50 radially about the circumference of the substrate 18. The sheet can then be retained in the compressed orientation by fixing longitudinal edges of the sheet together by conventional techniques such as a but joint or an overlapped, welded joint. In other embodiments, the metallic sheet can be initially formed to its desired final size, and the substrate with the material 50 wrapped thereon can be “stuffed” into the rolled sheet. This eliminates the need for the sheet to be separately compressed about the substrate and material 50, as compression occurs during the “stuffing” process.

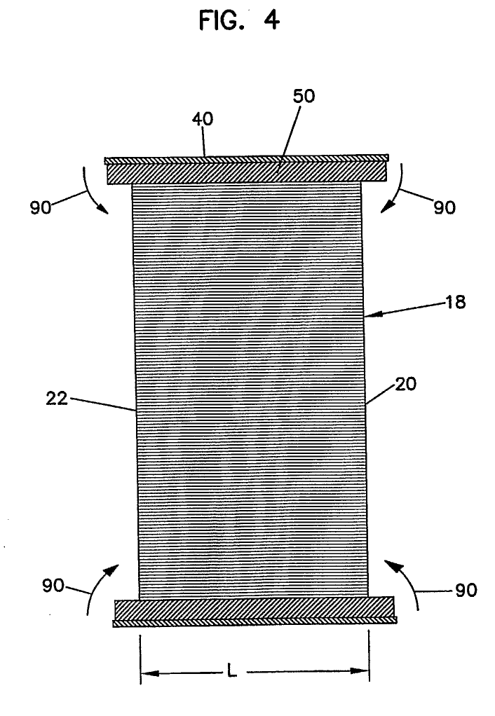

FIG. 4 shows the substrate 18 after the sheet has been mounted about the exterior of the substrate. As shown in FIG. 4, it is preferred for both the sheet 40 and the material 50 to have a length greater than a length L of the substrate 18. The length L is measured between the axial end faces 20, 22 of the substrate 18. The extra length provided by the sheet 40 and the material 50 allows the ends of the sheet 40 and the material 50 to be curled, bent, rolled or otherwise moved radially inwardly (indicated by arrows 90) to cause end portions of the material 50 to oppose and abut against the end faces 20, 22 of the substrate 20. The end portions of the sheet 40 retain and compress the end portions of the material against the end faces 20, 22. In this manner, the end portions of the sheet 40 and the end portions of the material 50 cooperate to securely retain the substrate 18 within the housing. The ends of the sheet 40 can be fully bent as shown in the embodiment of FIG. 1, or partially bent as shown in the embodiment of FIG. 2. By varying the amount the end portions of the sheet are bent, the amount of compressive force applied to the axial end faces 20, 22 can be precisely controlled.

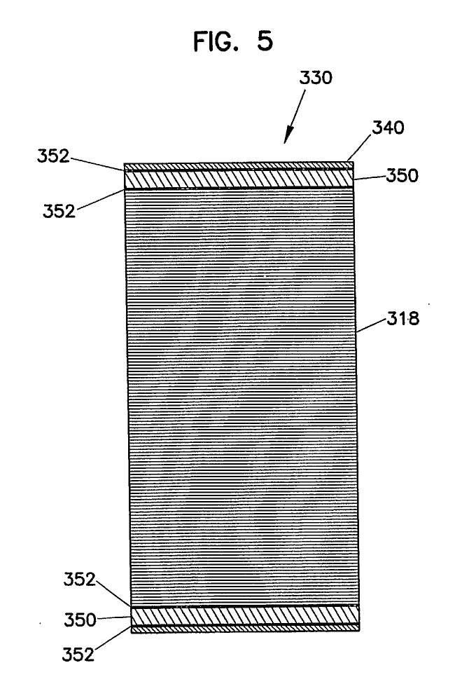

Non-intumescent mat materials often have material constructions that generate air borne fibers. These air borne fibers can present handling problems (e.g., skin irritation) during the handling and device assembly process. To overcome this problem, the non-intumescent mat material can be covered or encapsulated within a material such as a stretch wrap type of material (e.g., polyolefin). FIG. 5 shows an aftertreatment device 330 with a mat 350 positioned between a housing 340 and a substrate 318. The mat 350 is encapsulated between protective layers 352. While the protective layer overcomes the handling issues described above, it presents other problems. For example, it has been determined that the presence of the protective layer at the boundaries of the mat significantly reduces the axial substrate retention provided by the mat. This is particularly problematic in low temperature diesel exhaust applications, which often run at temperatures less than 300 degrees Celsius, because temperatures are generally insufficient to melt or oxidize the encapsulating material.

To overcome the above problem, Applicant's have developed a manufacturing step whereby the aftertreatment device including the non-intumescent mat is exposed to a heat curing cycle. Initially, the intent was to merely expose the device to sufficient heat to melt/oxidize the layers encapsulating the mounting layer. However, Applicant's surprisingly discovered that subjecting the aftertreatment device to a heat curing cycle in excess of that required to melt or oxidize the encapsulating material yielded unexpectedly improved substrate retention results as compared to what was achieved by merely melting/oxidizing the encapsulating material. The improvement can be evaluated by comparing the improvement to a base line value equal to the force required to push a substrate covered with a non-encapsulated mat material from a housing. In performing this comparison, the push-out force required to push a substrate covered with an encapsulated mat was about 24 percent less than the base line value. By heating the aftertreatment device to remove (e.g., oxidize/melt) the polymeric encapsulating material, the push-out force was raised to slightly above the base-line value. By heating the aftertreatment device to a temperature to at least partially oxidize the housing, the push-out force was increased to about 20 percent above the base line value. By heating the aftertreatment device to a temperature to at more completely oxidize the housing, the push-out force was increased to about 48 percent above the base line value.

Several factors resulting from the heat cure cycle are believed to positively affect substrate retention. For example, the heat cycle is believed to cause oxidation of the metallic can (which increases coefficient of friction at the boundary layer). The heat cycle also is believed to cause removal of any oils or other contaminants that are present at the boundary layers of the mat (mat to can and mat to substrate). The heat cycle further is believed to melt or oxidize the material used to encapsulate the mat. The heat cycle is also believed to release binders present in the “as purchased” mat material.

To achieve the above results, it is preferred for the heat cycle to be higher and/or of longer duration that what would be required to merely melt or oxidize the material used to encapsulate the mat. Preferably, the heating cycle is conducted as part of the initial manufacturing process, in a controlled manufacturing setting/environment (e.g., an oven or other controlled heating mechanism), prior to sale and installation of the aftertreatment device on an exhaust system. In one non-limiting embodiment, the core assembly is exposed to a temperature of 538 degrees Celsius for at least 15 minutes. This is but one example that has been found to yield beneficial results, and is not intended to limit the temperatures and durations that could be used. In one embodiment, the process is done on aftertreatment devices for diesel exhaust applications.

The actual process parameters of the heat cycle (time and temp) are a function of both the heating process (gas, electric, batch, flow thru, etc,) and the materials (oxidation rate, binder release, flash point, etc.). Oxidation (or other processes that would increase coefficient of the outer can material) could also be done prior to the assembly process to achieve partial retention improvement and eliminate heating curing the complete substrate assembly.

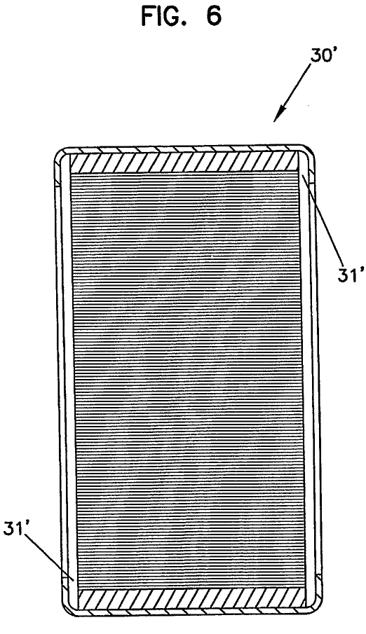

The present disclosure relates to processes for heating/curing aftertreatment devices that include non-intumescent mats to improve substrate retention. The mats of the aftertreatment devices may or may not be covered with a protective layer. The improvements in substrate retention can be achieved regardless of whether the protective layer is present on the mat or not. The heating processes described herein can be used in the manufacture of the devices shown in FIGS. 1-4, wherein end portions of the housing compress the end portions of the mat against the end faces of the substrate. The processes described herein can also be used to manufacture devices such as shown in FIG. 6. The device 30′ shown in FIG. 6 has a similar construction as the device of FIG. 1, except the ends of the housing have been extended and curled to protect the mat from direct impingement by the exhaust stream and gaps 31′ exist between the curled ends and end faces of the substrate.

The above specification and examples provide a complete description of the manufacture and use of the invention. Since many embodiments of the invention can be made without departing from the spirit and scope of the invention, the invention resides in the claims hereinafter appended.

What is claimed is:

1. An aftertreatment device comprising:
a substrate having an upstream face and a downstream face;
a mounting layer including a main portion that covers the perimeter of the substrate from the upstream end to the downstream end, and end portions that oppose the upstream and downstream faces of the substrate; and
an outer housing including a main portion that compresses the main portion of the mounting layer against the perimeter of the substrate between the upstream end and the downstream end, and end portions that compress the end portions of the mounting layer against the upstream and downstream end faces of the substrate.

2. An aftertreatment device according to claim 1, wherein the mounting layer includes non-intumescent material.

3. An aftertreatment device according to claim 1, wherein the outer housing and the substrate have a generally rounded profile, with the mounting layer forming a sleeve between the outer housing and the substrate.

4. An aftertreatment device according to claim 1, wherein at least one of the end portions of the outer housing defines a lip that extends continuously about the entire perimeter of the outer housing.

5. An aftertreatment device according to claim 1, wherein at least one of the end portions of the outer housing defines discrete substrate retention structures that are located at only portions of the entire perimeter of the outer housing.

6. An aftertreatment device according to claim 1, wherein the main portion of the mounting layer and the end portions of the mounting layer are integrally connected extending in a continuous fashion.

7. An aftertreatment device according to claim 1, wherein the outer housing includes metallic material.

8. An aftertreatment device according to claim 1, wherein the end portions of the outer housing are bent radially inwardly approximately 90 degrees relative to the main portion of the outer housing.

9. An aftertreatment device according to claim 1, wherein the end portions of the outer housing are bent radially inwardly at angles less than 90 degrees relative to the main portion of the outer housing.

10. An aftertreatment device according to claim 1, wherein the mounting layer includes intumescent material.

11. An aftertreatment device according to claim 1, wherein the substrate includes a catalyst.

12. An aftertreatment system comprising:
a substrate having an upstream face and a downstream face;
a mounting layer including a main portion that covers the perimeter of the substrate from the upstream end to the downstream end, and end portions that overlap portions of the upstream and downstream faces of the substrate; and
a substrate retention structure, wherein the mounting layer is located between the substrate retention structure and the substrate, the substrate retention structure including portions that compress the end portions of the mounting layer against the upstream and downstream end faces of the substrate.

13. An aftertreatment system according to claim 12, wherein the substrate retention structure is defined by an exhaust conduit in which the substrate and the mounting layer are mounted.

14. An aftertreatment system according to claim 13, wherein the exhaust conduit includes radially extending projections for retaining the substrate.

15. An aftertreatment system according to claim 14, wherein the radially extending projections form a continuous lip around the perimeter of the exhaust conduit.

16. An aftertreatment system according to claim 14, wherein the radially extending projections form a plurality of discrete, non-continuous projections located at only portions of the entire perimeter of the exhaust conduit.

17. An aftertreatment system according to claim 12, wherein the substrate retention structure is defined by an intermediate housing that is mounted within an exhaust conduit, the intermediate housing being mounted between the exhaust conduit and the mounting layer.

18. An aftertreatment system according to claim 17, wherein the intermediate housing includes a main portion that compresses the main portion of the mounting layer against the perimeter of the substrate between the upstream end and the downstream end and wherein the end portions of the intermediate housing are bent radially inwardly approximately 90 degrees relative to the main portion of the housing.

19. An aftertreatment system according to claim 17, wherein the intermediate housing includes a main portion that compresses the main portion of the mounting layer against the perimeter of the substrate between the upstream end and the downstream end and wherein the end portions of the intermediate housing are bent radially inwardly at angles less than 90 degrees relative to the main portion of the housing.

20. An aftertreatment system according to claim 12, wherein the mounting layer includes non-intumescent material.

21. An aftertreatment system according to claim 12, wherein the mounting layer includes intumescent material.

22. A method for making an aftertreatment device including a substrate, a metallic housing and a non-intumescent mat, the method comprising:
improving substrate retention by heating the aftertreatment device to a temperature and for a duration to cause oxidation of the housing and removal of at least some contaminants provided at boundary layers between the substrate and the mat and between the mat and the housing, the heating being part of a manufacturing process.

23. The method of claim 22, further comprising removing a protective layer from the mat during the heating of the aftertreatment device.

24. A method for making an aftertreatment device including a substrate, a metallic housing and a non-intumescent mat covered by a protective layer, the method comprising:
heating the aftertreatment device to a temperature and for a duration that causes substrate retention to be at least 20 percent better than a base line push-out value, the base line push-out value being equal to the force required to push the substrate from the housing when the substrate is wrapped in a mat that is not covered by a protective layer, the heating being part of a manufacturing process.

25. The method of claim 24, wherein the substrate retention is at least 30 percent better than the base line push-out value.

26. The method of claim 24, wherein the substrate retention is at least 40 percent better than the base line push-out value.

27. A method for making an aftertreatment device including a substrate, a metallic housing and a non-intumescent mat not covered by a protective layer, the method comprising:
heating the aftertreatment device to a temperature and for a duration that causes substrate retention to be at least 20 percent better than a base line push-out value, the base line push-out value being equal to the force required to push the substrate from the housing prior to heating, the heating being part of a manufacturing process.

28. The method of claim 27, wherein the substrate retention is at least 30 percent better than the base line push-out value.

29. The method of claim 27, wherein the substrate retention is at least 40 percent better than the base line push-out value.
